(19) United States
(12) Patent Application Publication
(10) Pub. No.: US 2023/0368240 A1
(43) Pub. Date: Nov. 16, 2023

(54) ELECTRICITY BANK FOR USE AT AN ELECTRIC VEHICLE CHARGING STATION

(71) Applicant: Rodney Senior, Fort Myers, FL (US)

(72) Inventor: Rodney Senior, Fort Myers, FL (US)

(21) Appl. No.: 18/112,381

(22) Filed: Feb. 21, 2023

Related U.S. Application Data
(60) Provisional application No. 63/313,683, filed on Feb. 24, 2022.

(51) Int. Cl. G06Q 30/0238; G06Q 30/0207; B60L 53/66

(52) U.S. Cl. CPC G06Q 30/0238; G06Q 30/0224; B60L 53/665

(57) ABSTRACT

Disclosed is a system of a prepaid Electricity Bank wherein a user may access the Electricity Bank and draw down a quantity of electricity units from user's EB available account balance to recharge an EV at an EV charging station. An entity such as an EV manufacturer, government agency, or utility may use the disclosed system to preload value into the Electricity Bank to incentivize EV sales and usage. A new category of third-party corporate entities such as supermarkets, retailers, wholesalers, manufacturers, or service providers may also issue credits to the Electricity Bank in order to promote the sale of their goods or services. The disclosed invention provides a harmonized means for public and private entities to pool value into the Electricity Bank to subsidize the cost of recharging an EV, thereby enhancing EV adoption and contributing to the pursuit of a cleaner environment.

### CROSS-REFERENCE TO RELATED APPLICATIONS

This Non-Provisional application claims priority to U.S. Provisional Patent Application No. 63/313,683, filed Feb. 24, 2022.

### FIELD OF THE INVENTION

The present invention relates to the field of Electric Vehicles (EVs), EV charging stations and EV electricity consumption. Adoption of EVs improves the environment by reducing the dependence on fossil fuels and related carbon emissions.

### BACKGROUND OF THE INVENTION

To make the switch from fossil fuel powered vehicles to EVs, people need a convenient and reliable network of fast charging stations for highway driving. ‘Range anxiety’ is a known impediment to the adoption of EVs because people fear running out of battery power before reaching the next charging station. A national network of DC Fast Charging (DCFC) stations is currently being developed, with federal government support, that should largely overcome this impediment. DCFCs are capable of recharging a vehicle up to 80% within thirty (30) minutes, which is much faster than an AC charger that is typically located at home or at a place of work. In contrast, filling up a vehicle tank with gasoline or diesel takes two (2) minutes and the average stop length including food, bathroom, etc., is fifteen (15) minutes. So, a 30-minute stop to recharge an EV at a DCFC takes twice as long and is therefore a disadvantage. Furthermore, there are no electricity cost savings at an DCFC compared with filling up with gasoline or diesel at a traditional gas station. The significant capital outlay for DCFC equipment plus higher electricity tariffs set by utilities at a DCFC renders the cost of recharging an EV at an DCFC more expensive than filling up an equivalent vehicle with gasoline or diesel. So, with double the wait time to recharge an EV, and no savings on the electricity consumed, there needs to be a cost v benefit justification for people to be persuaded to make the transition to EVs. The present invention of a prepaid Electricity Bank allows public and private sector entities to subsidize the partial or entire cost of recharging an EV, therefore enhancing the adoption of EVs.

A Level 3 DCFC costs between $40,000-$175,000 (before installation) depending on the number of ports, runs off 480 volt and 200 amp power lines, and recharges an EV battery to 80% in thirty (30) minutes. The high cost of DCFC equipment is due to the internal technology to convert AC from the electrical grid to DC.

The attached reference by Jim Gorzelany (myev.com>ev-101> what is costs to charge an Electric Vehicle) quotes as follows: “Unfortunately, while Level 3 is the fastest way to charge an EV, it's also the costliest. As an example, we were recently billed $0.29 a minute for DC Fast Charging in the Chicago area via an EVgo station. A 25-minute session that added around 50 miles of added range to a Volkswagen eGolf cost $7.25, which comes out to $3.62 for 25 miles. By comparison, the EPA says it costs an average of $2.26 to pilot the standard gas-powered VW Golf the same distance”.

To substantiate the above findings, a VW Golf has a 13.2 gallon gas tank that produces a 435 mile miles range (average of 33 mpg—see attached reference findlaynorthvw.com). Using the above-referenced figures, for a 435 mile range to recharge an eGolf at an DCFC costs $62.99 ($3.62×435/25) of electricity, whereas to fill up a VWGolf with gasoline to produce the same 435 miles costs $39.32 ($2.26×435/25).

Based on the above example which compares an eGolf with a VW Golf, it is 60% more expensive to recharge an EV at a DCFC than to fill up an equivalent vehicle with fossil fuel to obtain the same mileage range.

On Aug. 5, 2021, President Biden signed an executive order that set a goal of having EVs comprise 50% of cars and trucks sold in the US by 2030. On Nov. 15, 2021, the H.R. 3684 Infrastructure Investment and Jobs Act became law which will channel $7.5 billion into building a nationwide network of public EV charging stations. The Biden Administration's stated goal is to increase the number of EV charging stations in the US from 45,000 to 500,000. There needs to be sufficient number of EV charging stations to support the adoption of EVs.

In order to recharge an EV on the highway, EV drivers typically visit a public EV charging station, connect an EV to a charging port, and pay for the electricity consumed. Methods of payment include credit card, debit card, prepaid card, fleet card, EV charging station's payments app, or mobile wallet. The electricity consumed is charged to the method of payment presented.

A diversity of parties advocate the use of EVs by subsidizing the EV purchase price or the cost of home-based or work-based charging equipment. These parties include EV manufacturers, federal, state, local governments, and utility companies. Their common purpose is to promote cleaner energy by driving EV sales. However, the labyrinth of available subsidy programs is not easy to navigate.

EV manufacturers currently incentivize a vehicle sale by way of a subsidy in the form of a discount or cash rebate.

Federal government subsidizes an EV purchase by way of a federal income tax credit.

State governments offer rebates and discounts when a new, leased, or used EV is registered. Other incentives include retail sales and use tax subsidies, or tax exemptions on the purchase of an EV.

Municipalities offer free dedicated metered parking and free public charging for EVs.

Utility companies offer electricity bill rebates on the purchase or lease of an EV, and loans to finance a purchase of EVs. Utilities also offer electricity bill rebates to customers who install a home or work-based EV charger. These programs are designed to promote greater consumption of electricity from their grid.

The above diversity of incentives to promote EV usage have inefficiencies and complexities. Examples are given below.

Federal government provides a federal tax credit of $2500-$7500 against a purchase of an EV depending on its make and model. For example, the federal tax credit for a Kia Niro is $7500, Lincoln Aviator is $6534, and Toyota Prius is $4502. This incentive benefits only those individuals or entities that owe sufficient income tax in the current tax year to cover the available tax credit. Furthermore, the credit cannot be rolled over to future tax years. Therefore, this income-based federal tax credit is inequitable. Also, the federal tax credit is limited to first 200,000 EVs sold by a specific manufacturer and the federal tax credit is currently being revised to discriminate against buyers of an EV with battery components that are sourced overseas.

State government incentives vary by state and are complicated. For example: Oregon offers a rebate of $2500 for the purchase or lease of an EV with a battery capacity over 10 kWh, and $1500 for a battery capacity of less than 10 kWh.

Oregon Department of Environmental Quality offers a further income-based rebate of $5000 for the purchase or lease of an EV. Residents are required to complete an income eligibility calculator to see if they qualify for a rebate. Rebates are restricted to EVs that are registered in Oregon for at least two years and that have a suggested retail price of under $50,000.

Massachusetts Electric Vehicle Incentive Program (MassEVIP) provides grants for workplaces and multi-unit dwellings. For non-residential sites installing Level 2 EV charging equipment that is accessible to the public for at least 12 hours a day, MassEVIP provides up to $6,250 per charging port, and a maximum of $50,000 for hardware and software costs per site.

For workplaces of at least 15 employees on-site and multi-dwelling with at least 10 residential units, MassEVIP provides funding of up to 60% for purchasing EV charging equipment. New York State EV tax credit provides up to $5,000 tax deduction for the purchase and installation of a new EV charging station.

Local government EV incentives are also complicated and diverse. For example: Sarasota County, FL, offers a rebate for the installation of qualified Level 2 station or Level 3 DCFC. Businesses are eligible for a rebate up to $2,000, and non-profits or government organizations are eligible for a rebate up to $4,000.

City of Lodi, CA, offers rebates of $500 and $3000 respectively for residential and commercial installations of EV chargers.

Lodi Electric Utility, CA, applies a rate schedule for electricity consumption ranging from $0.1428/kWh to $0.3366/kWh depending on time-of-use. This schedule is applicable to single-phase electric vehicle charging service in single-family and multi-family dwellings separately metered by the city.

Tucson Electric Power, AZ, (TEP) offers a rebate to residential customers that covers up to 75% of the cost of an EV charging equipment installation. The maximum rebate awards are $500 for a two-way charger and $250 for a one-way charger.

Snohomish County PUD, WA, offers a $500 rebate to customers for the purchase and installation of a qualifying Level 2 Energy Star EV charger in their homes. Customers must live in a single-family home, manufactured home, or condominium, purchase and install a Level 2 connected charger from a qualified product list, apply within 90 days, and agree to provide, or authorize the EV charger manufacturer to provide, PUD access to their charging data (data collection will be used to conduct research on EV charging patterns and their collective effect on PUDs electrical system and develop strategies to mitigate their impact).

Utility incentives offered by the 3300 independently operated electric utility companies in the United States are also varied and complicated. Utilities incentivize the consumption of electricity from their own grid by way of a rebate for installing a home-based or work-based EV charger, discount from a home electricity bill, or loan financing for the purchase or lease of an EV. Incentive programs differ for each utility. For example:

Nevada Energy, NV, incentive program covers the installation of workplace and residential EV charging stations. Depending on the nature of the business or organization, numerous grants and programs are available under the general umbrella of Nevada's electric car rebates, incentives, and funding for EVs and EV charging stations. The value of the grants varies, but they typically cover the majority, and sometimes the entirety, of purchase and installation costs.

Duquesne Light Co, PA, offers its residential and commercial customers a one-time bill credit for the purchase or lease of a plug-in electric vehicle.

Seattle City Light, WA, has installed 50 kW fast public EV charging stations across its service area. Its charging cost structure varies by location and time of day from $0.1982 kWh-$0.3564 kWh.

EV manufacturers, government agencies and utilities offer tax incentives and rebates that are currently linked to the purchase or lease of an EV, or the installation of EV charging equipment. The background information provided above describes an array of different EV incentive programs which are difficult to navigate.

There is a need for a simpler and harmonized means for public and private entities to pool value into the Electricity Bank to subsidize the cost of recharging an EV at an EV charging station, thereby enhancing EV adoption and contributing to the pursuit of a cleaner environment.

There is also a need for a system whereby a new category of corporate sector entities can incentive EV sales and usage by pooling prepaid electricity value into the Electricity Bank that a user may access to pay for the partial or entire cost of recharging an EV at EV charging stations. Said corporate sector organizations include supermarkets, food product manufacturers, banks, credit unions, pharmacies, pharmaceutical companies, quick service restaurants, stationers, entertainment, wholesalers, home improvement, home electronics, department stores, dollar stores, auto and tire centers, big box stores, coffee shops, fast food, liquor stores, online retailers, financial institutions, credit card companies, insurance, and loyalty program rewards programs. There is currently no harmonized system or method for said corporate sector organizations to incentivize the adoption of EVs and thus make a contribution to a cleaner environment. There is a need for a system of a prepaid Electricity Bank which said entities can use by issuing rewards such as rebate coupons, promotional coupons, or QR codes that a user may apply to add credits to user's Electricity Bank account in order to promote the sale of the said corporate entities' goods or services.

### SUMMARY OF THE INVENTION

Disclosed is a system of a prepaid Electricity Bank (EB) wherein an entity may use the disclosed system to preload value into the Electricity Bank that may be redeemed for electricity units to recharge an EV at an EV charging station, thereby subsidizing the partial or entire cost of recharging an EV. The invention describes a method comprising of:
A user having an EB account containing an available balance of electricity units available to recharge an EV battery at an EV charging station.
An entity such as an EV manufacturer, government agency, or utility, having access to EB to preload value to a user's EB account.
A user adding a credit to an EB account by applying a rebate coupon, promotional coupon, QR code or other promotional device issued by a third-party such as a supermarket, retailer, wholesaler, manufacturer, or service provider.
A user adding a credit to an EB account by purchasing an additional quantity of electricity units using a payment method such as ACH, credit card, debit card, fleet card or mobile wallet.
A financial float account being credited with proceeds from credits and purchases, being held in said float account balance pending redemption, and redeemed amounts being paid from said float account to utilities, EV charging stations or authorized retail merchants.
A user being authenticated at an EV charging station by presenting a unique identifier such as an open-loop prepaid card, debit card, or credit card such as a co-branded Visa or Mastercard, or a closed-loop prepaid card, ID card, key fob, mobile phone, smartwatch, mobile wallet, tablet, handheld device, facial recognition, fingerprint or iris scanner with an optional PIN or password entry for further security.
An EV being authenticated at an EV charging station by RFID vehicle recognition, other contactless technologies, or other means of authenticating an EV.
Available EB account balance and transaction history being displayed on a user's computer, mobile phone, smartwatch, tablet or other handheld device.
Available balance of EB account being displayed on EV charging station equipment or authorized retail merchant equipment.
A user redeeming a quantity of electricity units from an EB account at an EV charging station by connecting an EV charging port to an EV, recharging EV battery, and the quantity redeemed being subtracted from user's EB account balance.
Alternative method of payment being requested at an EV charging station if a user's EB account balance is insufficient to cover the amount redeemed.
Receipt being generated by EB and issued by EV charging station equipment or a receipt being displayed on a user's mobile phone application, smartwatch application, tablet, or other type of handheld device, such receipt displaying the quantity of electricity units consumed and remaining balance.
Balance in a user's EB account being provided by EB and displayed on EV charging station equipment, or on a user's mobile phone application, smartwatch application, tablet or other type of handheld device.
Financial float account being debited for the quantity of electricity units redeemed, and a corresponding settlement made to a utility, EV charging station, or authorized retail merchant where the redemption was made.
A user transferring a quantity of electricity units from user's EB account to a different EB account and the quantity transferred being subtracted from user's EB account balance.
Repeating the above steps thereby summing further purchases or credits to an EB account, or subtracting further redeemed or transferred quantities of electricity units from an EB account.

The present invention provides a harmonized method for EV manufacturers federal, state, and local governments, and utilities and to incentivize the purchase of an EV by preloading value to a user's EB account, thereby subsiding the partial or entire cost of recharging an EV battery at EV charging stations, enhancing the adoption of EVs, and promoting a cleaner environment.

The present invention also provides a harmonized method for a new category of corporate sector entities to issue promotional coupons or QR codes that a user may apply to credit a user's EB account, thereby subsiding the partial or entire cost of recharging an EV at EV charging stations, enhancing the adoption of EVs, and promoting a cleaner environment.

### BRIEF DESCRIPTION OF THE DRAWINGS

FIG. 1 is an overview of the system architecture using the Internet as a preferred means of connecting information and system components. Electronic Data Transfer, VPNs, or dial-up computer networks can be used as an alternative means of communication in regions without Internet capabilities. Depicted are the major data flow routes, beginning from one of four points i) EV charging station where a user redeems a quantity of electricity units from available Electricity Bank (EB) account balance using a prepaid card, mobile phone, smartwatch, tablet, handheld device, or mobile wallet or ii) Non-specific location where a user connects to EB using an Internet browser such as a mobile phone, smartwatch, or tablet, or personal computer to perform a purchase, credit, transfer, or to check account balance or iii) a third-party location wherein an entity preloads value into the Electricity Bank or iv) an EV charging station or authorized retail merchant where a user redeems value from EB account balance for goods or services other than electricity using a prepaid card, mobile phone, smartwatch, tablet, handheld device, or mobile wallet. EB, web server, and computer database operate on an API real-time platform. In this embodiment, a mirrored system is housed at a location discrete from the EB computer database and web server system. Routine daily offsite data backup is utilized to enable system recovery in the event of a failure or malfunction. Remote access to any part or whole of the system must first be granted authorization via the security measures in place at the firewall.

FIG. 2 is a conceptual map of the possible functions routing from the first data flow point being a user's personal access device such as a mobile phone, tablet, smartwatch, or other handheld device. A user is first authenticated and then initiates communication with EB using said personal access device. In this embodiment, all communications between a user's personal access device and the machines that make up the complement of EB are preferably completed via the Internet. The functions depicted are for a user to:
a) purchase electricity; select a quantity of electricity units to be purchased, add said quantity of electricity units to a user's EB account, present and verify a method of payment, the system returning a receipt including a confirmation number, transaction authorization code, or other transaction detail, to a user via email, text message, or other means, and the system providing an updated EB account balance.
b) credit electricity; present and validate a rebate coupon, promotional coupon, QR code, or other third-party promotional device and apply it to credit a user's EB account with a quantity of electricity units or equivalent coupon or QR code value, the system returning a receipt including a confirmation number, transaction authorization code, or other transaction detail, to the user via email, text message, or other means, and the system providing an updated EB account balance.
c) redeem electricity; user presents a unique identifier such as a prepaid card or digital device such as a mobile phone, smartwatch, or tablet at an EV charging station. User is authenticated, redemption transaction is authorized, user recharges EV battery by redeeming a quantity of electricity units from user's EB account, the quantity redeemed is debited from said user's EB account, the system returning a receipt including a confirmation number, transaction authorization code, or other transaction detail to the user via email, text message, or other means, and the system providing an updated user EB account balance.
d) redeem for goods or services other than electricity; user presents a unique identifier such as a prepaid card or digital device such as a mobile phone, smartwatch, or tablet at an EV charging station or authorized retail merchant and redeems value from user's EB account for goods or services other than electricity, the value redeemed being debited from user's EB account, the system returning a receipt including a confirmation number, transaction authorization code, or other transaction detail to the user via email, text message, or other means, and the system providing an updated user EB account balance.
e) transfer electricity; choose a quantity of electricity units to be transferred, select a different EB account to which the chosen quantity of electricity units is to be transferred, debit the transferor's EB account, and credit the transferee's EB account, and the system returning a receipt including a confirmation number, transaction authorization code, or other transaction detail to the user via email, text message, or other means, and the system providing an updated transferor's EB account balance.

FIG. 3 is a conceptual map depicting an authorized entity such as an EV manufacturer, government agency, or utility accessing EB and preloading a quantity of electricity units or equivalent value to a user's EB account as an incentive reward for purchasing or recharging an EV, and said entity making a corresponding payment to a float account. Also depicted is a third-party such as a supermarket, retailer, wholesaler, manufacturer, or service provider issuing a rebate coupon, promotional coupon, QR code as an incentive reward for a user purchasing said third-party's goods or services. A user enters said coupon code or scans said QR code into a personal access device such as a mobile phone, smartwatch, tablet, or personal computer which connects with EB and transmits coupon or QR code details to EB, and user's EB account is credited with a quantity of electricity units or equivalent value represented by said coupon or QR code. EB makes an invoice claim on said third-party for said coupon or QR code value, and said third-party settles via EB for said rebate coupon or QR code invoice claim value and float account is credited with said value, user's EB account balance is updated with said value and new balance is displayed on a user's personal access device.

FIG. 4 depicts a user performing purchase, credit, transfer, and check balance functions plus administrative, sorting, interrogatory, and browsing functions at a non-specific location using an Internet browser such as a personal computer, mobile phone application, smartwatch application, tablet, or other handheld device. A user first initiates communications using standard web browsing software and interfaces with EB following a linear path in a drill-down model, where a system navigation bar contains the designated actuation controls for each functionality path.

FIG. 5 depicts a user redeeming a quantity of electricity units from user's EB account at an EV charging station, or redeeming value from user's EB account for goods or services other than electricity at an EV charging station or authorized retail merchant. User is first authenticated by presenting a unique identifier such as a mobile phone, smartwatch, handheld device and may be further validated by use of a secure PIN or password. User presents a method of payment such as a prepaid card or a payment type embedded in a mobile wallet. The EB returns the available account balance, and upon completion receives the redemption transaction detail, updates the user's EB account balance, authorizes payment from float account to utility, charging station or authorized retail merchant for said redemption, and sends updated account balance to user. In this preferred embodiment, all communications between a user's personal access device such as a mobile phone, smartwatch, handheld device and the machines that make up the complement of EB, are completed via the Internet.

FIG. 6 depicts the various entities that currently issue EV incentives and the diagram showing the various types of incentives currently used to promote EV sales and usage. By making use of the present invention, the diagram illustrates how said entities can redirect their incentive contribution to an EB account. Said entities may either directly access EB to preload value to an EB account or alternatively may issue a rebate coupon, promotional coupon, QR code which a user may apply to credit an EB account. Payment proceeds from said entities for the quantity of electricity units issued by either method are deposited into a float account pending redemption.

FIG. 7 illustrates examples of different types of third-parties that may issue rebate coupons, promotional coupons or QR codes which a user may apply to credit a user's EB account. EB also provides said third-parties with customer data that enables them to e-communicate with EV owners for the purpose of promoting said third-parties' goods or services.

FIG. 8 illustrates of a typical account statement generated by EB. The statement is set out in the same format as a typical online banking statement with Credit, Debit, and Balance columns. The Transaction History column details the source, date, and time of a credit or debit. The statement may be displayed in a monetary denomination (e.g. dollar) and/or in quantity electricity units (kWh), at the user's option.

FIGS. 9A, 9B, and 9C illustrate typical mobile phone application or smartwatch application screens when a user connects to EB in order to perform the following functions:

FIG. 9A—Home Page
Choose Amount, Payment, Receipt
Credit, Receipt

FIG. 9B—Authorize, Redeem, Complete
Transfer, Transfer To
Map of Charging Stations

FIG. 9C—Balance
How it Works, Offers, EV Purchase Incentives

### DETAILED DESCRIPTION OF THE INVENTION

The present invention relates to a system of a computer-based prepaid Electricity Bank (EB) wherein a user has a unique EB account number containing an available balance of electricity units available to recharge an EV battery at an EV charging station. The system may be accessed by an authorized entity such as an EV manufacturer, government agency, or utility, either directly or indirectly, to preload value into said unique EB account to incentivize a user to purchase or recharge an EV.

The present invention also teaches a novel method for a new category of third-party corporate such as supermarkets, retailers, wholesalers, manufacturers, or service providers to issue value in the form of a rebate coupon, promotional coupon, or QR code that a user may apply to credit a user's EB account. The system also captures valuable customer data from which said third-parties can benefit by e-communicating directly with EV owners to promote their goods or services.

The system may be accessed by a user for the purposes of; crediting an EB account by applying a rebate coupon, promotional coupon, QR code or other promotional device issued by a third-party such as a supermarket, retailer, wholesaler, manufacturer, or service provider; or redeeming from an EB account for a quantity of electricity units at an EV charging station; or redeeming from an EB account for goods or services other than electricity at an EV charging station or authorized retail merchant; or purchasing a quantity of electricity units to credit an EB account; or transferring a quantity of electricity units from an EB account to a different EB account; or checking an EB account balance.

A novel aspect of EB is that it creates a means for entities such as EV manufacturers, federal, state, and local governments, or utilities to preload value into a unique user EB account that a user may access in order to redeem a quantity of electricity units to recharge an EV at an EV charging station, said entities thereby subsidizing the partial or entire cost of recharging an EV. The present invention offers a simpler alternative to the complexities and inequities inherent in the current income tax deduction and discount incentive programs for EV purchases, and rebates for various types of EV charging equipment, and discounts for EV registration, and a range of time-of-day utility rates as incentives. The present invention teaches a uniform means for said entities to add value to a user's EB account which can be used to redeem for electricity units at an EV charging station, the present invention thereby offering a novel means for said entities to accelerate the adoption of EVs and contribute to the pursuit of a cleaner environment.

The preferred communication means for the EB is via the Internet thereby providing users with the ability to access their EB account at home, at work, at an EV charging station, or at a non-specific Internet access location which offers wireless connectivity via a personal access device, tablet, mobile phone, smartwatch, or other handheld device.

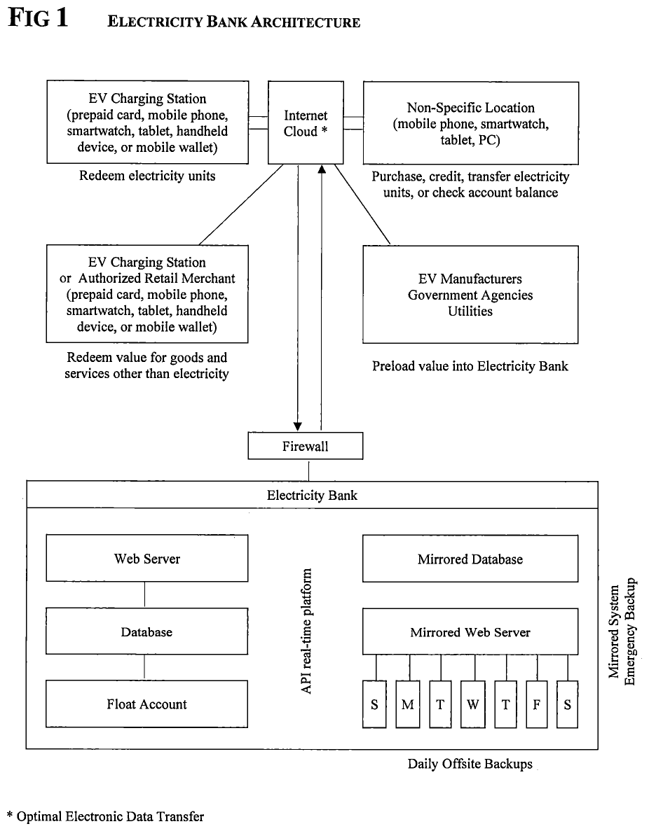

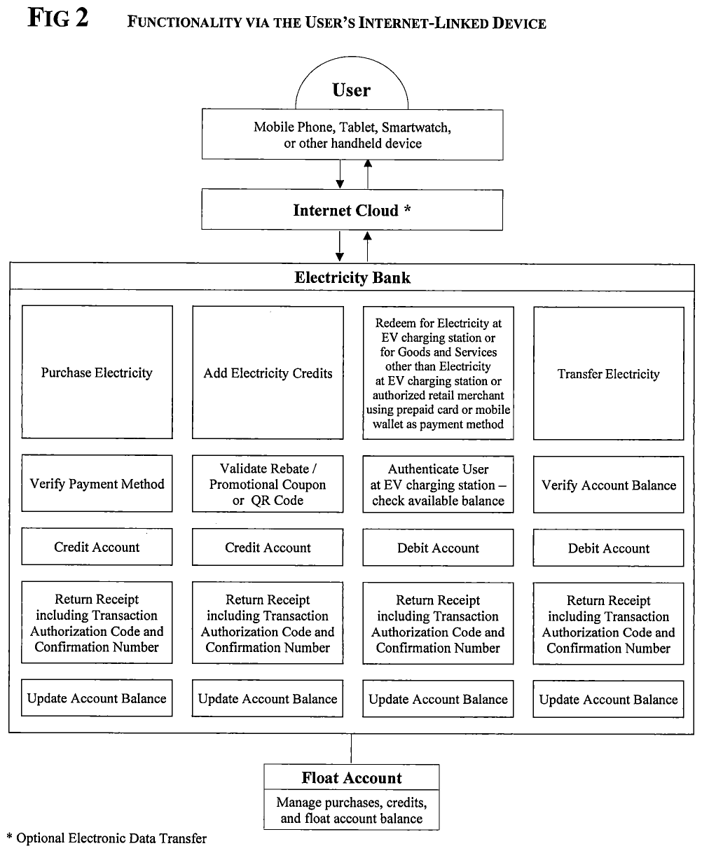

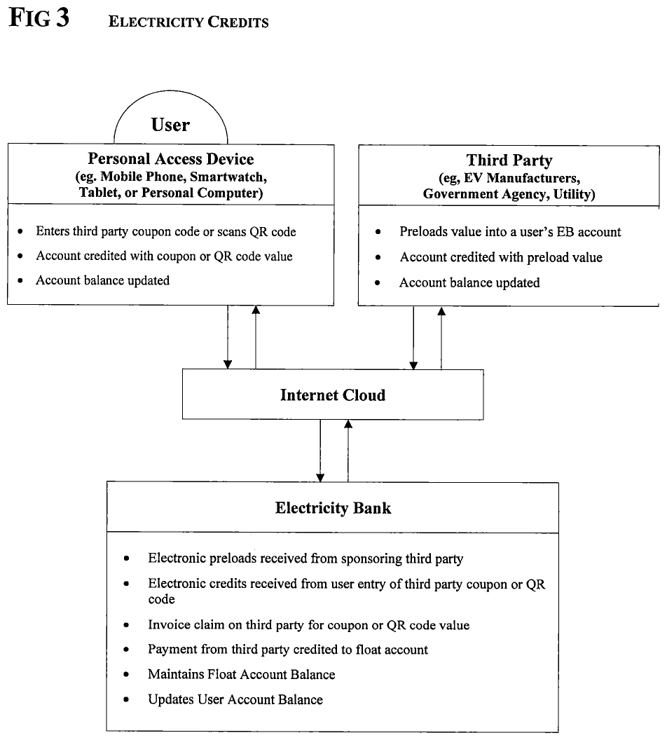

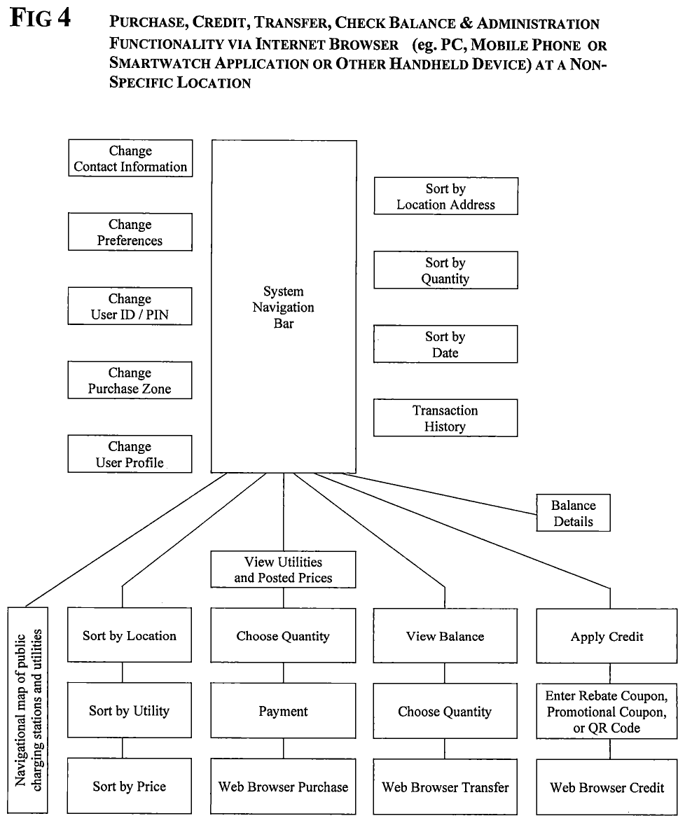

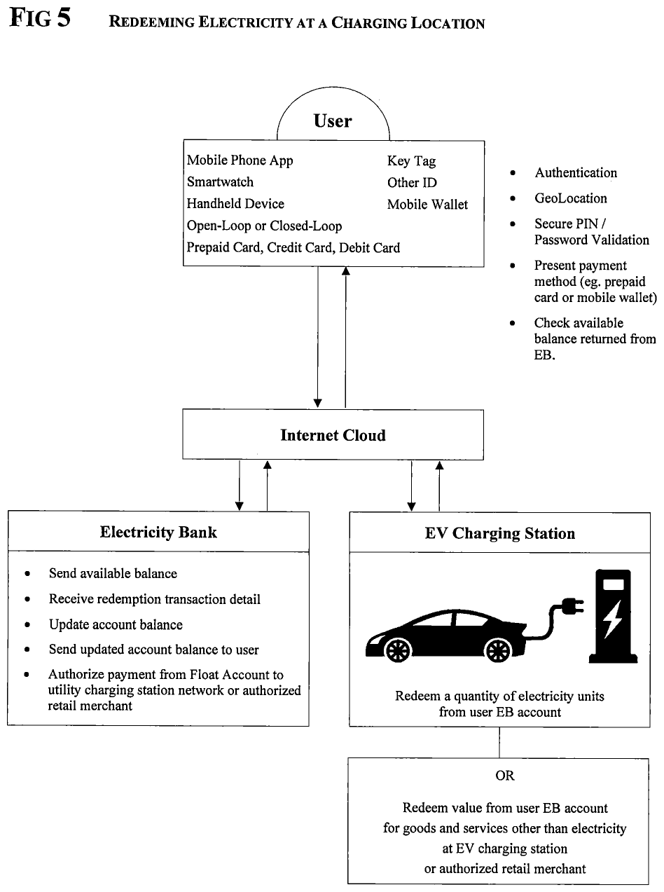

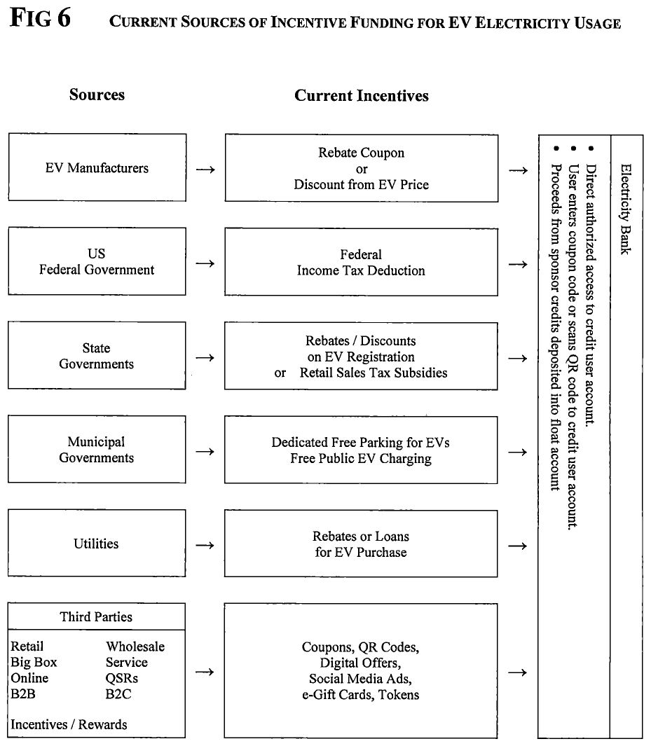

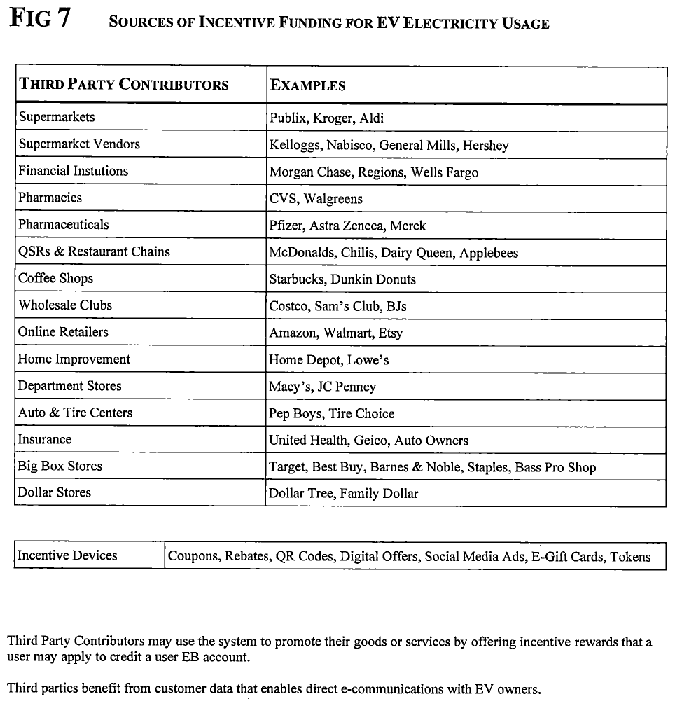

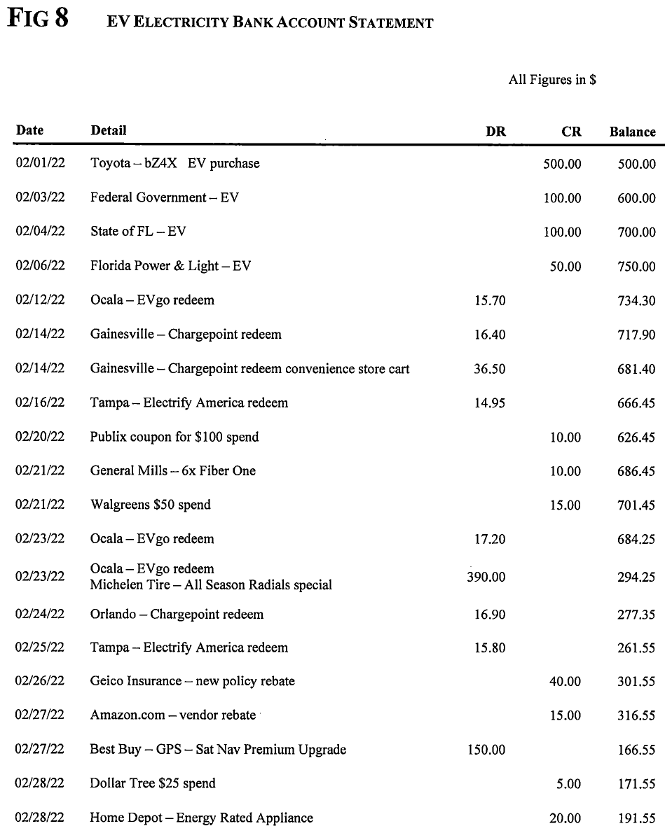

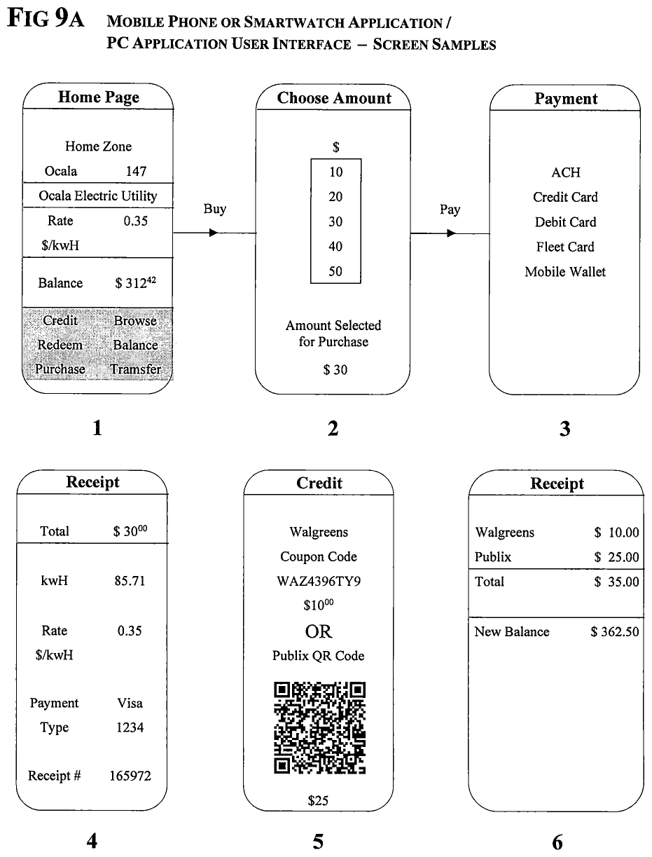

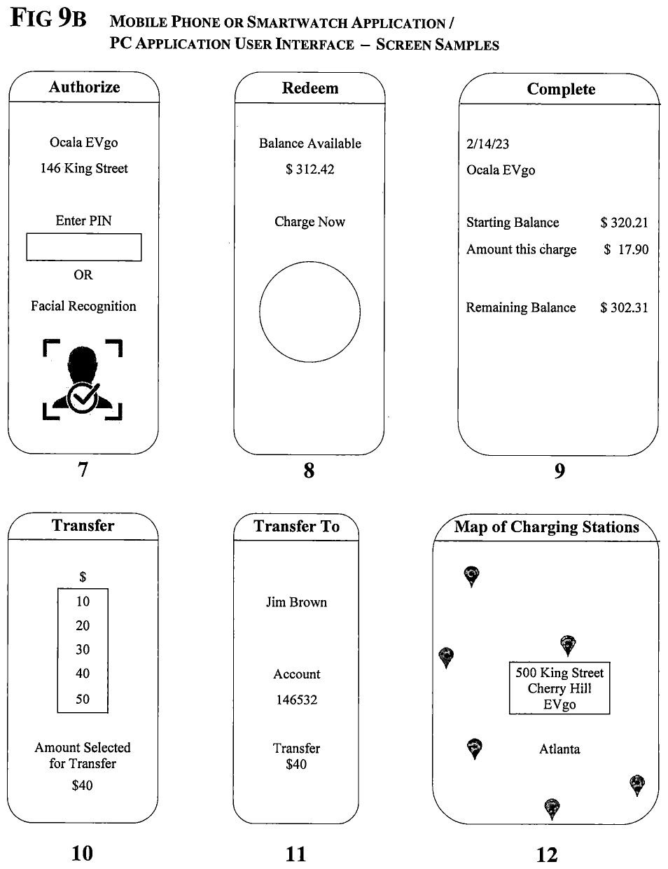

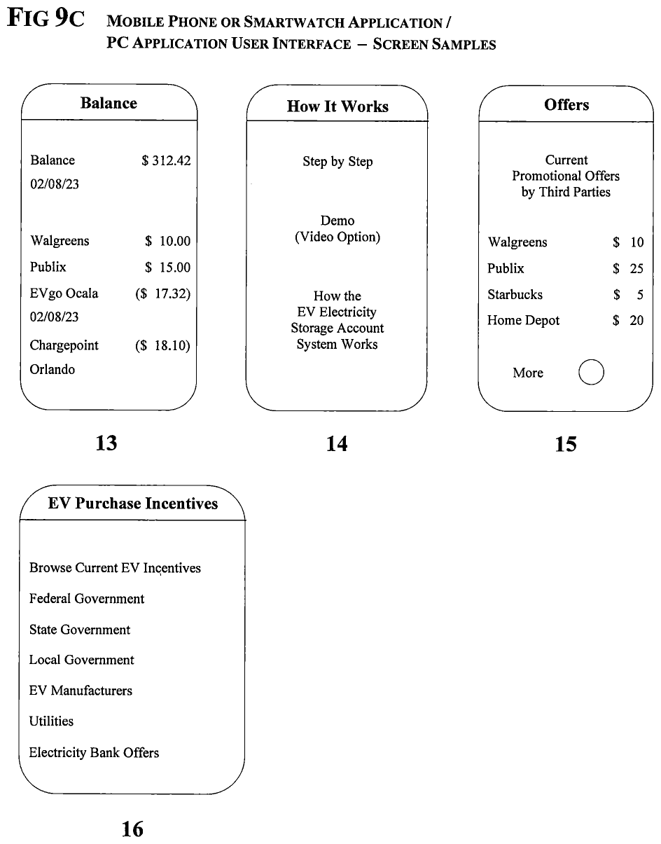

Referring to FIG. 1, shows an overview of the system architecture using preferably the Internet as a means of connecting information and system components in one embodiment. Electronic Data Transfer, VPN's or dial-up computer networks can be used as an alternative means of communication in regions without Internet capabilities. Depicted are the major data flow routes beginning from one of four points i) EV charging station where a user may redeem a quantity of electricity units from EB account balance using a prepaid card, mobile phone, smartwatch, tablet, handheld device, or mobile wallet or ii) Non-specific location where a user may connect to EB using an Internet browser such as a mobile phone, smartwatch, or tablet, or personal computer to perform a purchase, credit, or transfer transaction, or to check EB account balance or iii) a third-party location wherein an entity may preload value into the EB or iv) an EV charging station or authorized retail merchant where a user may redeem value from EB account balance for goods or services other than electricity using a payment method including a prepaid card, mobile phone, smartwatch, tablet, handheld device, or mobile wallet. EB, web server, and computer database operate on an API real-time platform. In this embodiment, a mirrored system is housed at a location discrete from the EB computer database and web server system. Routine daily offsite data backup is utilized to enable system recovery in the event of a failure or malfunction. Remote access to any part or whole of the system must first be granted authorization via the security measures in place at the firewall.

The method comprises maintaining a computer database system containing information relating to utilities and electricity rates, identifying the quantity units as kilowatt hours (kWh) and equivalent monetary values, both of which are used as optional denominations in an EB account, identifying the unit price of electricity to be purchased or credited, and displaying this value in the system catalog. As an example, a user EB account statement may be optionally expressed in either kWh or dollars and a user may choose to view the statement expressed in either or both denominations. It should be noted that, as used herein, the expressions “units” and “quantity units” do not necessarily refer to specific values of kWh but may also refer to another measure such as monetary measure including dollars, pounds sterling or euros.

EB accounts are created for a user or potential user that may take place as part of a pre-registration process wherein a user may submit personal information such as name, address, email address and phone number. In this way, a registration process can occur on-line or off-line. Each user may be assigned a unique secure access code or other means to transact online with EB. Pre-registration is typically associated with a reloadable EB account where there may be regulatory requirements to ‘know your customer’. Alternatively, an EB account may be created anonymously wherein no personal information is associated with the account and said pre-registration may not be required. Said anonymous EB accounts are typically non-reloadable accounts in which an initial balance is depleted with no reloads being allowed.

An authorized entity such as an EV manufacturer, government agency, or utility, is provided with designated actuation controls to instruct the system to preload value to a user's EB account as an incentive reward for purchasing or recharging an EV. Said preload may be performed either by direct or indirect access to the EB. Upon receipt of a preload, the system updates user EB account balance, sends an e-communication to said user and to said entity confirming details of said preload. The system also maintains said preload in a float account balance and provides supporting data to a financial institution responsible for managing payments in and out of the float account.

Designated actuation controls are available for a user to instruct the system to apply a credit to a unique user EB account by entering details from a rebate coupon, promotional coupon, QR code or other promotional device issued by a third-party such as a supermarket, retailer, wholesaler, manufacturer, or service provider. The system updates the user account balance, sends an e-communication to the user and to said third-party confirming details of the credit and makes an invoice claim on the third-party for the coupon or QR code value. The system also maintains said credit in a float account balance and provides supporting data to a financial institution responsible for managing payments in and out of the float account.

Designated actuation controls are available for a user to instruct the system to purchase a quantity of electricity units online at its current posted price in a user's home zone. A user's home zone is typically defined geographically by a user's zip code, or computer IP address at a user's home or place of work. Designated actuation controls are used to instruct the system which method of payment to use for completing the purchase. Methods of payment include ACH, credit card, debit card, fleet card or different methods of payment embedded in a mobile wallet. Upon completion of purchase, the system updates user's EB account balance, send an e-communication to the user confirming details of the purchase, and maintains said purchase credit in a float account balance and provides supporting data to a financial institution responsible for managing payments in and out of the float account. EB maintains a historical archive of all credits, debits and balances relating to said float account. After a user completes an online purchase transaction, transaction details are verified, financial data for automated payment for a quantity of electricity units purchased are obtained and recorded, and the system database is updated, therein reflecting a transaction in a user's EB account history. The method includes the option of connecting EB directly to separate and distinct financial institutions for real-time credit approval before a purchase can take place. In this way, automated payment confirmation is carried out, as and when required.

A financial institution or other entity may be designated as the custodian of the float account and which financial institution or other entity may also be designated to manage the float account, to receive payments to the float account for preloads, credits and purchases, and to make payment and settlements from the float account to utilities, EV charging stations, or authorized retail merchants for redemptions made.

Designated actuation controls are provided for a user to instruct the system to transfer a portion a user's EB account balance to a different EB account. To perform this instruction, a user selects a quantity of electricity units from user's EB account balance, selects a different EB account to which the chosen quantity of electricity units are to be transferred, debits the transferor's EB account and credits the transferee's EB account, the transferor and transferee either being the same user or different users, and the system returning a receipt including a unique confirmation number, transaction authorization code, or other transaction detail to the user via email, text message, or other means, and the system providing an updated EB account balance.

To redeem from an EB account, a user is first authenticated at an EV charging station, or authorized retail merchant, by presenting a unique identifier such as an open-loop prepaid, debit card, or credit card such as a Visa or Mastercard, a closed-loop card, ID card, key fob, mobile phone, smartwatch, tablet, handheld device, facial recognition, fingerprint or iris scanner. Identification may be conducted either by contact or contactless communication. User authentication may also be by PIN, password, or other electronic means.

Alternatively, an EV is authenticated at an EV charging station by RFID vehicle recognition, other contactless technologies, or other means of authenticating an EV.

After a user or an EV is authenticated at an EV charging station or authorized retail merchant, user presents a method of payment including a prepaid card or a payment type embedded in a mobile wallet, EB returns the available balance in user's EB account, a redemption transaction is authorized, a user may redeem all or a portion of an available EB account balance for electricity units to recharge an EV battery at an EV charging station after physically connecting the EV to a charging port in order to receive the electricity, or a user may redeem all or a portion of an available EB account balance for goods or services other than electricity at an EV charging station or authorized retail merchant, the amount redeemed being debited from user's EB account, the system returning a receipt including a unique confirmation number, transaction authorization code, or other transaction detail, and an updated account balance to the user via email, text message, or other electronic means. EB also communicates details of each redemption and updated float balance to the financial institution responsible for the float account, such institution then being enabled to pay out a settlement to the EV charging station, utility or authorized retail merchant where the redemption took place.

A preferred embodiment refers to a user being provided with a card that is associated with user's EB account such as an open-loop prepaid card such as a prepaid Visa or prepaid Mastercard, or a prepaid closed-loop card, as a unique identifier or payment card at an EV charging station or authorized retail merchant. Said card may be presented at the redemption location to identify and authenticate a user, and to preauthorize a redemption transaction up to an available balance in a user's EB account. Said card may also be embedded in a mobile wallet, wherein a mobile phone application or smartwatch application is used to identify and authenticate a user, preauthorize and pay for a redemption transaction. In this preferred embodiment, a float account is held by an issuing bank for said prepaid card while EB maintains transaction records and float balances that are used to reconcile with said monetary float account held by an issuing bank. An example would be a float account held at MetaBank which could be the issuing bank for a reloadable or a non-reloadable prepaid Mastercard or closed-loop card, that is issued to an EV owner and associated with EV owner's EB account.

A non-reloadable prepaid card associated with an EB account may be issued to a user when an entity preloads value into said user's EB account. When the EB account balance is depleted by redemptions or transfers from said EB account, the card has no further value with no reloads or credits being permitted. In contrast, a reloadable prepaid card associated with an EB account may be issued to a user wherein a reload may take place when: an entity preloads value into said EB account via authorized access to EB; or a credit is added to the EB account by a user applying a rebate coupon, promotional coupon, or QR code issued by a third-party; or a user performs a purchase transaction; or a transfer is made into said EB account from a different EB account.

The system comprises at least one web server computer designed for serving a host of computer web browsers simultaneously and providing said browsers with the capability of interfacing with the system, wherein each browser can transact a quantity of electricity units. The web server co-operates with a separate database computer, separated from the web server computer by a firewall. The database computer is accessible to the web server computer to allow selective retrieval of information which can include:
Information about a utility
Quantity of electricity units to be transacted
Current posted electricity rates for a utility

The web server computer can include custom written interface software for transacting electricity units in the system database computer by displaying, during a transaction or at any other time, the current posted price of electricity, providing a designated user actuation control for instructing the system to purchase or credit electricity units at a posted price, continually updating a price, and continually updating all aspects of the system display as a user uses the interface to interact with the database.

The present invention provides a harmonized means for government agencies, EV manufacturers, utilities and for third-parties such as supermarkets, retailers, wholesalers, supermarkets, and service providers to pool value into the EB, thereby subsidizing the partial or entire cost of recharging an EV, enhancing the adoption of EVs, and contributing to the pursuit of a cleaner environment.

Referring to FIG. 2, a user is first authenticated using a personal access device such as a mobile phone, tablet, smartwatch, personal computer, or handheld device, and then initiates communication with EB using said personal access device. In this embodiment, all communications between a user's personal access device and the machines that make up the complement of EB are preferably completed via the Internet. The transactions depicted in FIG. 2 enable a user to:
a) purchase electricity; user selects a quantity of electricity units to be purchased, credits the purchased quantity to a user's EB account, presents and verifies a method of payment, confirms the purchase, and the system returning a receipt including a unique confirmation number or code or other transaction details to a user via email, text message, or other means, and system displaying an updated EB account balance. EB enables financial proceeds from said credit to be deposited into a float account.
b) credit electricity; user presents and validates a rebate coupon, promotional coupon, QR code, or other promotional device issued by a third-party and applies it to credit a user's EB account by inputting said coupon code or scanning said QR code using a computer or handheld device such as a mobile phone application or smartwatch application. Said third-party issuer could include an EV manufacturer, government agency, utility, supermarket, retailer, wholesaler, manufacturer, or service provider. The quantity of electricity units or equivalent value represented by said coupon or QR code is credited to user's EB account balance, the system returning a receipt including a unique confirmation number or other transaction details to a user via email, text message, or other means, and system displaying an updated EB account balance. EB enables financial proceeds from said credit to be deposited into a float account.
c) redeem electricity; user presents a unique personal identifier such as a prepaid card or digital device such as a smartphone, smartwatch, or other handheld device at an EV charging station and may enter a security PIN or password if prompted, user selects a method of payment which may be a prepaid card or a payment type within a mobile wallet, redemption transaction is authorized, EB returns available balance in user's EB account that is displayed on a user's device or on EV charging station equipment, user recharges an EV battery at an EV charging station by physically connecting a charging port to an EV, redeeming a quantity of electricity units from EB account the quantity redeemed being debited from said EB account balance, and EB returning a receipt including a unique confirmation number and other transaction details to a user via email, text message, or other electronic means, and EB providing an updated EB account balance for display on a user's device and/or on EV charging station equipment.
   A user may redeem value from an available EB account balance for goods or services other than electricity at face value, or at a promotional price, or by taking advantage of a special offer. For example, a user may be offered a discounted price for fast food items, or a cross-sell promotional offer of two for one on convenience store items, or an upsell promotional offer of a free upgrade to more expensive tires, in order to entice a user to spend from EB account. Such redemptions can take place after said authentication process either at an EV charging station or authorized retail merchant. Upon completion of a redemption transaction EB displays an updated EB account balance for display on a user device and/or on EV charging station equipment or authorized retail merchant equipment and EB returns a receipt including a unique confirmation number and other transaction details to a user via email or text message.
d) transfer electricity; designated actuation controls are provided for a user to instruct the system to transfer a quantity of electricity units from a user's EB account balance to a different EB account; choose a quantity of electricity units to be transferred, select a different EB account to which the chosen quantity of electricity units will be transferred, debit the transferor's EB account and credit the transferee's EB account, and the system returning a receipt including a unique confirmation number, transaction authorization code, or other transaction detail to the user via email, text message, or other means, and the system providing an updated EB account balance.

Referring to FIG. 3, in this embodiment, an authorized entity such as an EV manufacturer, government agency, or utility accesses EB and preloads a quantity of electricity units or equivalent value to a user's EB account as an incentive reward for purchasing or recharging an EV, and said entity makes a corresponding payment to a float account.

Alternatively, a third-party such as a supermarket, retailer, wholesaler, manufacturer, or service provider may issue a credit in the form of a rebate coupon, promotional coupon, QR code as an incentive reward for a user purchasing said third-party's goods or services. A user enters said coupon code or scans said QR code into a personal access device such as a mobile phone, smartwatch, tablet, or personal computer which connects with EB and transmits coupon or QR code details to EB, thereby crediting user's EB account with a quantity of electricity units or equivalent value represented by said coupon or QR code. EB returns the account balance which may be displayed on a user's device. EB makes an invoice claim on a third-party for said coupon or QR code value. Said third-party settles via EB for said rebate coupon or QR code invoice claim value and float account is credited with said value.

Referring to FIG. 4, this depicts a conceptual map of the possible functions routing from an Internet browser such as a personal computer, mobile phone application, smartwatch application, tablet, or other handheld device being at a non-specific location. A user initiates communications using standard web browsing software device and interfaces with the system following a linear path in a drill-down model, where a system navigation bar contains the designated actuation controls for each functionality path. User functions include purchasing, crediting, or transferring a quantity of electricity units, or checking account balance; sorting utilities by name, location and price; sorting transaction history by date, location, and quantity; managing user ID, password, contact information, user home zone and address.

Once connected to EB, a user may use the system navigation bar to:
change personal contact information, preferences, user ID and PIN, home zone, or user profile.
sort transaction data by location, quantity, date, and other historical detail.
sort data by utility, location, price.
request EB account balance details.
navigate a map depicting EV charging station locations, addresses and utilities that supply electricity to said locations.
view a utility posted price, choose a quantity, select method of payment, and purchase a quantity of electricity units.
credit EB account by applying a third-party rebate coupon, promotional coupon or QR code.
view EB account balance, select a quantity, and transfer a quantity from user's EB account balance to a different EB account.

Referring to FIG. 5, this depicts a user redeeming a quantity of electricity units from EB at an EV charging station, or redeeming value from EB for goods or services other than electricity at an EV charging station or authorized retail merchant. A user is first authenticated by presenting a unique identifier such as a mobile phone, smartwatch, other Internet-connected handheld device or key tag, or by connecting an open-loop prepaid card, closed-loop prepaid card, debit card, or credit card with EV charging station equipment and may be further validated by entering of a secure PIN or password. User presents a method of payment such as a prepaid card or a payment type embedded in a mobile wallet within a user's mobile phone application or smartwatch application wherein said open-loop or closed-loop card or other payment type may be embedded as a valid method of payment. A user's device or EV charging station equipment displays the available EB account balance in a user's EB account, EB authorizes a redemption transaction. User physically connects a charging port to an EV and charges the battery thereby consuming electricity units. If there is insufficient balance in a user's EB account to cover the quantity of electricity units consumed at an EV charging station, either the electricity supply is cut off when an EB account balance is depleted, or an alternative method of payment is requested for any overage. EB receives the redemption transaction detail upon completion of the transaction, updates the user's EB account balance, authorizes payment from float account to utility, charging station or authorized retail merchant for said redemption, and sends updated account balance to user. In this preferred embodiment, all communications between a user's personal access device such as a mobile phone, smartwatch, handheld device and the machines that make up the complement of EB, are completed via the Internet.

Referring to FIG. 6, this embodiment shows the variety of incentives currently used to promote EV sales and usage. By making use of the present invention, the diagram illustrates how said incentives can be harmonized and redirected as contributions to the EB. The listed entities and types of incentives offered are by no means exhaustive and are shown on FIG. 6 only by way of examples. Said listed entities are provided authorized access to EB in order to preload value to a user's EB account or alternatively, said listed entities may issue a rebate coupon, promotional coupon, QR code, or other promotional device which a user may apply to credit an EB account. EB makes a claim on the issuing entity by invoice or other means, obtains payment from the issuing entity for said coupon or QR code value, and payment proceeds are deposited into a float account.

Referring to FIG. 7, this embodiment depicts a plurality of third-party corporate entities that may issue rebate coupons, promotional coupons QR codes, or other promotional devices which a user may apply to credit a user's EB account. EB also provides said third-party entities with customer data that enables them to e-communicate with EV owners for the purpose of promoting said third-party goods or services. The disclosed invention provides a novel system and method for said third-party corporate entities to subsidize the partial or entire cost of recharging an EV. Examples of said third-parties include:
Supermarkets and their food product vendors that supply them
Financial Institutions
Pharmacies
Pharmaceutical companies
Quick Service Restaurants & Fast-Food chains
Coffee Shops
Wholesale Clubs
Online Retailers
Home Improvement Stores
Department Stores
Auto & Tire Centers
Insurance Companies
Big Box Stores
Dollar Stores

Referring to FIG. 8, this embodiment illustrates a typical account statement generated by EB. The statement is set out in the same format as a typical online banking statement with Credit, Debit and Balance columns. The Transaction History column details the source, date, and time of a credit or a debit. The date and time of a credit or debit are also shown. The statement may be sorted by date or transaction type and is capable of being exported in a format suitable for printing. The statement and historical transaction data are available, at a user's option, in a quantity denomination (kWh) and/or a monetary denomination (e.g. dollars).

Referring to FIGS. 9A, 9B, and 9C this embodiment illustrates typical mobile application or smartwatch application screen sequences when a user connects with EB:

FIG. 9A
HOME PAGE (Screen 1)
Home Page shows a user's home zone, name of a utility associated with a user's home zone, and current electricity rates. A user may select from the following six transaction types—Purchase, Credit, Redeem, Transfer, Browse, Balance.
CHOOSE AMOUNT (Screen 2)
Choose Amount—user actuates a control to select a quantity of electricity units from a drop down. The display shows the selected quantity multiplied by a rate to compute a selected dollar value of a purchase.
PAYMENT (Screen 3)
Payment—user actuates a control to select a method of payment.
PURCHASE RECEIPT (Screen 4)
Receipt—confirms purchase transaction details. User actuates a control to confirm and submit payment.
CREDIT (Screen 5)
Credit—user enters a rebate coupon code, promotional coupon code, or scans a QR code issued by a third-party issuer. The screen displays source and value of a coupon. A user actuates a control and credits EB account with the coupon or QR code value.
CREDIT RECEIPT (Screen 6)
Receipt—confirms credit transaction details.

FIG. 9B
AUTHORIZE (Screen 7)
Authorize—shows location detail if available via geolocation from a user's mobile phone, smartwatch, or other device. User enters PIN, password, facial recognition, EV contactless RFID, or other means of authenticating a user or EV.
REDEEM (Screen 8)
Redeem—displays available EB account balance. User actuates a control to recharge an EV with electricity units at an EV charging station and debit EB account with the quantity of electricity units consumed. The same redemption function allows a user to redeem value from EB account for goods or services other than electricity at an EV charging station or authorized retail merchant.
COMPLETE (Screen 9)
Complete—confirms starting EB account balance, amount charged, and closing EB account balance.
TRANSFER (Screen 10)
Transfer—user actuates a control to select an amount from a drop down.
TRANSFER TO (Screen 11)
Transfer To—user assigns a different EB account to which a transfer is to be made.
MAP OF CHARGING STATIONS (Screen 12)
Map—depicts a navigational map of EV charging station locations. These locations may also carry a name of an associated utility and current electricity rates for each location. This will help to familiarize a user with the concept of different price zones in locations away from a user's home zone.

FIG. 9C
BALANCE (Screen 13)
Balance—shows historical transaction details and current EB account balance.
HOW IT WORKS (Screen 14)
How It Works—a step-by-step demonstration of how EB works.
OFFERS (Screen 15)
Offers—allows a user to drill down to review current promotional offers made by third-parties such as supermarkets, retailers, wholesalers, manufacturers, or service providers as incentive rewards for purchasing said third-parties' goods or services.
EV PURCHASE INCENTIVES (Screen 16)
EV Purchase Incentives—allows a user to drill down to review current incentive offers made by entities such as EV manufacturers, federal, state, local governments, and utilities to promote EV sales and usage. These offers may be income tax deductions, rebates, discounts for purchase of an EV or EV charging equipment. The present invention also allows the screen display to include offers made by said entities as preloads, coupons or QR codes to credit a user's EB account.

In addition to the above activities, a user is provided with general information about EB, system security and privacy, and a customer help line.

In various forms of the present system, price zone features can be utilized. Each price zone has a certain utility or group of utilities supplying it and, as a result, prices of electricity vary by price zone. The system database is periodically updated with up-to-date information about various utilities and their current price structure.

The system may utilize the price zone information in two manners:

In a first form, the system allows a user to purchase a quantity of electricity units to redeem from a user's EB account in a user's home zone. A home zone is typically associated with a user's zip code at home or place of work, or a user's computer IP address.

In a second form, the system allows a user to purchase a quantity of electricity units to redeem from a user's EB account in a price zone different from the user's home zone (Away Zone). It should be noted that the monetary value of a user's available EB account balance remains the same in all zones. However, the available quantity account balance represented in electricity units (kWh) changes by price zone according to the different utility unit prices prevailing in different price zones.

Before a redemption takes place in an Away Zone, an available EB account value balance may be displayed to a user either on an EV charging station equipment display or via a user's mobile phone application, smartwatch application or other type of handheld device. After a redemption is complete, EB decrements the value of the redemption amount from a user's EB account balance. EB automatically converts the redeemed quantity of electricity units in the Away Zone into an equivalent quantity of electricity units in the user's home zone. For this calculation, a redeemed quantity of electricity (in kWh) is multiplied by the quotient of the current Away Zone electricity unit price divided by the current home zone electricity unit price. For example:
Electricity units redeemed in Away Zone 80 kWh
Current Away Zone unit price $0.30/kWh
Current home zone unit price $0.20/kWh
Equivalent quantity of electricity units redeemed in home zone=80×0.30/0.20=120 kWh.

In the above example, EB accounts for electricity units consumed by deducting 120 kWh from the balance of electricity units in a user's home zone EB account. EB also maintains an equivalent monetary value balance. EB database therefore maintains both monetary and electricity unit balances in a user's EB account and is capable of providing statements in denominations of either monetary and kWh units. It is important for utilities, EV charging stations, EV manufacturers, government agencies, and for users to capture and maintain data of both kWh quantity units consumed in addition to monetary value of electricity consumed by an EV, and to be able to maintain and track EB account balances in quantity units (kWh) and monetary units (e.g. dollars). The disclosed EB provides all those capabilities.

Although various preferred embodiments of the present invention have been described herein in detail, it will be appreciated by those skilled in the art, that variations may be made thereto without departing from the spirit of the invention or the scope of the appended claims.

What is claimed is:

1. A system of a prepaid Electricity Bank (EB) that allows; an entity such as an Electric Vehicle (EV) manufacturer, government agency, or a utility to preload a quantity of electricity units or equivalent value to credit a user's EB account as an incentive reward for purchasing or recharging an EV; a third-party such as a supermarket, retailer, wholesaler, manufacturer, or service provider to issue a credit for a quantity of electricity units or equivalent value to apply to a user's EB account as an incentive reward for a user purchasing said third-party's goods or services; a user to redeem from the user's available EB account balance a quantity of electricity units for recharging an EV at an EV charging station, the claimed invention simplifying the plethora of EV incentive programs currently offered by said entities and said third-parties and providing a novel means for public and private entities to encourage the adoption of EVs by pooling value into the prepaid Electricity Bank thereby subsidizing the partial or entire cost of recharging an EV, the system comprising:
a computer-based system for transacting electricity units over an Internet-based communications network and which computer-based system includes, a computer database containing user transaction history, account balance of electricity units, electricity rates and other information pertaining to at least one utility company, and
a computer-based system performing an electronic credit transaction wherein an authorized entity such as an EV manufacturer, government agency, or utility connects to EB and preloads a quantity of electricity units or equivalent value into a user's EB account, and EB updating said user account balance and providing a digital receipt to said entity and to said user for said credit transaction, and
a web server computer for interacting with the computer database and also for interacting with at least one client computer such as a personal computer, mobile phone, smartwatch, tablet, or other type of handheld device configured to be used by a user, the web server computer designed to allow a user to:
perform an electronic credit transaction wherein a third-party such as a supermarket, retailer, wholesaler, manufacturer or service provider issues a rebate coupon, promotional coupon, or QR code, each said coupon or QR code containing a unique identifying code that a user may input or scan into said client computer to credit user's EB account with a quantity of electricity units or equivalent value represented by said coupon or QR code, and EB updating said user EB account balance, and providing a digital receipt to said third-party and to said user for said credit transaction; and
redeem at least a portion of the user's EB account balance for a quantity of electricity units at an EV charging station, wherein the user; is authenticated using a unique identifier such as a prepaid card, mobile phone, smartwatch, tablet, or other type of handheld personal access device; presents a method of payment including a prepaid card or mobile wallet that is linked to the user's EB account and the EB returning the available balance of electricity units in the user's EB account for display on the user's client computer; physically connects an EV charging port to an EV and redeems at least a portion of the user's EB account balance for a quantity of electricity units used for recharging an EV battery, and upon completion of the redemption transaction the EB subtracting from user's EB account balance the quantity of electricity units redeemed and the EB providing a digital receipt to said user for said redemption transaction and said receipt capable of being sent by email or text message; and
repeat, using the computer-based system, at least one of the steps of performing a credit transaction for a quantity of electricity units or equivalent value, or redeeming at least a portion of the EB account balance for a quantity of electricity units or equivalent value, the system adjusting the current EB account balance to reflect the user transaction from the step of repeating.

2. The system of claim 1 wherein said unique identifier is presented at the redemption location by more than one person.

3. The system of claim 1 wherein said web server computer interacts with the client computer at a plurality of locations.

4. The system of claim 1 wherein the user performs an electronic purchase transaction comprising the purchase from the computer database of a quantity of electricity units at a current posted electricity unit price as reflected in the computer database, the purchase transaction resulting in said purchased quantity of electricity units being summed with the EB account balance.

5. The system of claim 1 wherein at least a portion of the user's EB account balance is transferred in the computer database to credit a different EB account balance.

6. The system of claim 1 wherein the user pre-registers an EB account by submitting personal information such as name, address, and phone number.

7. The system of claim 1 wherein the authentication at an EV charging station is performed on the user's EV using RFID vehicle recognition technology.

8. The system of claim 1 wherein the payment card type presented could be a non-reloadable prepaid card or a reloadable prepaid card, wherein said card may be embedded in a mobile wallet.

9. The system of claim 1 wherein the computer database maintains a float account balance which reflects credit and redemption transactions and reflects corresponding payments from the crediting entities and payments to redeeming entities.

10. The system of claim 1 wherein the computer database maintains an account balance in a monetary denomination (eg dollar) and wherein credit and redemption transactions performed on the system are in said monetary denomination.

11. The system of claim 10 wherein a redemption is made from an available EB account balance for goods or services other than electricity at an EV charging station or authorized retail merchant.
